(19) United States
(12) Patent Application Publication
(10) Pub. No.: US 2017/0016775 A1
(43) Pub. Date: Jan. 19, 2017

(54) SURFACE TEMPERATURE PROBE

(71) Applicant: ABB Schweiz AG, Baden (CH)

(72) Inventors: Andreas Decker, Darmstadt (DE); Joerg Gebhardt, Mainz (DE); Paul Szasz, Plankstadt (DE); Stephan Wildermuth, Laudenbach (DE)

(21) Appl. No.: 15/210,922

(22) Filed: Jul. 15, 2016

(30) Foreign Application Priority Data
Jul. 17, 2015 (DE) 20 2015 103 789.9

(51) Int. Cl. G01K 1/08

(52) U.S. Cl. CPC G01K 1/08

(57) ABSTRACT

A surface temperature sensor has a first geometric contact surface for determining the temperature in a vessel and a second geometric contact surface, wherein the first geometric contact surface and the second geometric contact surface are in point—and/or linear contact and at least partially spaced variably from this. For a long-term stability, low heat transfer resistance a metal foam is provided between the first geometric contact surface and the second geometric contact surface.

### CROSS-REFERENCE TO RELATED APPLICATIONS

Priority is claimed to German Patent Application No. DE 20 2015 103 789.9, filed on Jul. 17, 2015, the entire disclosure of which is hereby incorporated by reference herein.

### FIELD

The invention relates to a surface temperature probe for industrial use.

### BACKGROUND

Industrial surface temperature probes are known, per se, in a number of designs. Common to most of said probes is the fact that the actual temperature sensor element—usually a Pt100 resistor or a thermocouple—is encapsulated in a metal housing in order to prevent damage in tough industrial environments. Additional adapter structures (plates, clamps) are often used in order to allow attachment to a process pipe or vessel. The sensor arrangement thus formed is brought into contact with the process pipe or container at which the temperature is to be measured. The measuring accuracy of such sensor arrangements is strongly influenced by the thermal resistance of the contact between the process pipe or container and the sensor housing or the adapter structure.

Due to technical quality, such as surface roughness and tolerances, the actual body contact on the process pipe is limited to just a few point contacts, for example if two planar but not perfectly level surfaces contact one another, or in the best case line contacts, for example between a pipe and a plate, the contact surfaces being small in comparison to the overall surface of the sensor element. This leads to a very high heat transmission resistance and thus to long reaction times and significant steady-state deviations between the actual surface temperature and the measured value. In this case, the deviations can certainly exceed 10° C.

It is generally known to reduce the heat transmission resistance between two thermally coupled elements by means of heat-conducting materials, such as heat-conducting pastes. However, known heat-conducting pastes are unsuitable for use in an industrial environment. Since the known heat-conducting pastes dry at high temperatures or run off over a long period of time, the thermal contact resistance increases, leading to measurement errors.

In addition, solid heat-conducting materials are known. However, the maximum operating temperature of silicone-based solid heat-conducting materials is too low for industrial applications. Graphite and soft metal foils are very stiff and only suitable for compensating low surface tolerances—in the region of gap width changes of less than 50 μm.

However, in industrial practice, in particular on curved surfaces such as pipes and containers, gaps having variations in thicknesses of several 100 μm are to be evenly filled in order to provide sufficient heat contact.

### SUMMARY

An aspect of the invention provides a surface temperature probe, comprising: a first geometric contact surface configured to determine a temperature in a vessel including a second geometric contact surface, wherein the first geometric contact surface contacts the second geometric contact surface in a punctiform and/or linear manner, wherein the first geometric contact surface is variably spaced apart from the second contact surface at least in part.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 is a partial sectional schematic view of a surface temperature probe mounted on a container wall;

FIG. 2 is a partial sectional schematic view of a surface temperature probe mounted on a process pipe; and

FIG. 3 is a partial sectional schematic view of a surface temperature probe mounted on a container wall by means of an adapter.

### DETAILED DESCRIPTION

An aspect of the invention is to provide a surface temperature probe, the thermal contact of which on the contact surface of the pipe or container is designed to have long-term stability over a wide temperature range, while having a low heat transmission resistance and being designed for bridging gaps having variable thickness variations.

An aspect of the invention proceeds from a surface temperature probe comprising a first geometric contact surface for determining the temperature in a vessel comprising a second geometric contact surface, the first geometric contact surface contacting the second geometric contact surface in a punctiform and/or linear manner and being variably spaced apart from said second contact surface at least in part.

According to an aspect of the invention, a metal foam is provided between the first geometric contact surface and the second geometric contact surface.

Advantageously, metal foams of this kind have a higher heat conductivity than metal particles in a paste, as are known in the form of heat-conducting paste, because a plurality of continuous metal paths are provided between the first geometric contact surface and the second geometric contact surface.

In addition, metal foams of this kind are easily adaptable to the first and the second geometric contact surface. As a result, low-resistance thermal contact is achieved, in particular for the surface contacts having a poor fit, which leads to a higher precision and shorter reaction time in comparison with conventional surface-mounted sensors. The solution according to the invention also has long-term stability, in contrast to conventional heat-conducting pastes, in particular at temperatures significantly higher than 100° C.

According to an additional feature of the invention, the metal foam consists of a metal having high heat conductivity. In particular, the metal foam consists of silver, copper or aluminum. However, within the framework of the invention, foams made of other suitable metals can also be used, it being possible in principle to also consider alloys.

According to an additional feature of the invention, the metal foam has a high porosity.

Advantageously, as a result, deformations of the metal foam for adaptation to the first and the second geometric contact surface are facilitated, since a high porosity is typically associated with a low flow stress.

According to an additional feature of the invention, the metal foam has a metal foam pore volume of between 80 and 95 vol. %.

Advantageously, the density of the foam can be selected on the basis of the mounting forces.

According to an additional feature of the invention, the metal foam has a pore size of <1 mm.

Advantageously, the heat transfer for a foam having small pores is more homogeneous than for a foam having large pores, in particular for random pore size distribution.

The thickness of the metal foam is selected such that, with the given flow stress and mounting forces, sufficient deformation is made possible to compensate the varying gap width.

A thickness of from 1 to 4 mm is particularly advantageous. It has been found that thinner foams do not have sufficient volumes to compensate large gap changes. Thicker foams have a higher thermal resistance and may be more difficult to adapt mechanically to the geometries that are to be thermally connected. However, depending on the design and tolerances, thinner and thicker foam layers can be used.

The sensor is mounted using suitable means which generate a sufficiently high contact pressure. The mounting forces must be sufficiently high in order to exceed the flow stress of the foam such that the metal foam is deformed on the contact surface to an extent that results in the largest possible expansion gaps for filling the contact, ideally for complete filling. Complete filling does not mean that there are no pores, but rather, in the context of this disclosure, complete filling means that both contact interfaces are brought into contact by the foam over the entire surface, each residual gap being smaller than the pore size of the foam.

Depending on the degree of deformation required, the deformation of the foam can be plastic or elastic or a combination of both. The combination of plastic and elastic deformation is particularly advantageous. The plastic deformation causes a good gap filling irrespective of the geometric shape of the corresponding contact surfaces, while the elastic deformation of the foam is advantageous in compensating temporal changes of the gap width, such as are caused by temperature changes, drift and the like.

The required flow stress can also be achieved by heating the foam to a temperature at which the yield strength is reduced, if the required deformation cannot otherwise be achieved.

Due to the porous structure of the metal foam, up to 30% of the thickness can be deformed in compression even by relatively low forces. This low flow stress makes deformation possible without damaging the sensor housing.

According to an additional feature of the invention, it is provided for an irregularly folded metal foil which has a metal foam structure to be arranged between the corresponding contact surfaces.

In this way, the foam produces a large number of contact points on both bearing surfaces, which contact points are connected to a material having high heat conductivity. As a result, a heat transmission structure is achieved, the thermal stability and service life of which significantly exceed those of heat-conducting pastes.

For contact gaps having large gap width variations of more than 1 mm, the metal foam can be preformed to the rough dimensions. In particular, it can be provided to preform the metal foam to a tolerance of <0.5 mm for the gap width, for example by bending, pressing or machining, so that low deformation is achieved during mounting and thus the mounting force required is reduced.

According to an additional feature of the invention, the metal foam is filled at least in part with a soft material of high thermal conductivity. Advantageously, the heat transmission resistance between the contact surfaces is further reduced and the thermal contact improved by this feature.

In a preferred embodiment, the metal foam is filled with a heat-conducting paste.

In an alternative embodiment, the metal foam is filled with a metal having a low melting temperature. In particular, but not exclusively, tin and indium are suitable for this purpose.

In both embodiments, the capillary action of the metal foam prevents the loss of the heat-conducting paste or of the soft metal at high temperatures. Preferably, the metal foam in these embodiments has a pore size of <0.5 mm.

The surface temperature sensor is mounted on the process pipe or container wall using suitable means, such as clamps or other means for attachment. When mounting the surface temperature sensor, the metal foam is pressed together in the contact interface by the sensor mounting apparatus and, in the process, is deformed until the metal foam completely fills the contours of the contact gaps and thus results in full surface contact and high heat conductivity.

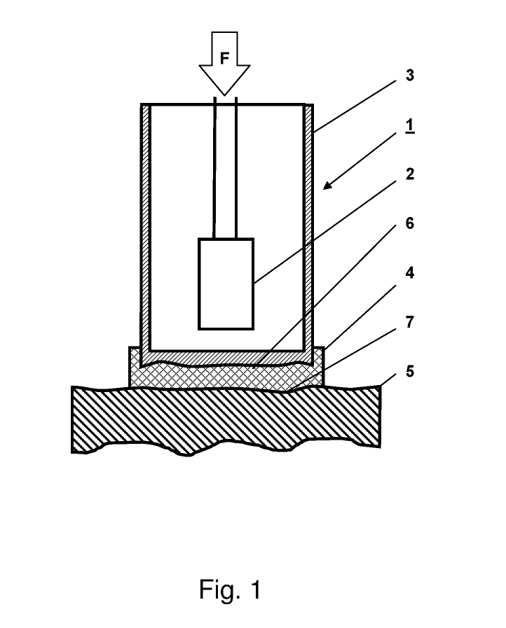

FIG. 1 shows a surface temperature probe 1 in which a temperature sensor 2 is housed in a sensor housing 3. The surface temperature probe 1 is mounted on the wall of a vessel 5. In this case, the surface temperature probe 1 comprises a substantially planar first geometric contact surface 6 and the wall of the vessel 5 comprises a substantially planar second geometric contact surface 7, the contour of the first geometric contact surface 6 differing from the contour of the second geometric contact surface 7 so as to form a contact gap.

A metal foam 4 which fills the contact gap is inserted in said contact gap between the first geometric contact surface 6 of the surface temperature probe 1 and the second geometric contact surface 7 of the wall of the vessel 5. In addition, the surface temperature probe 1 is mounted on the vessel 5 by means of a contact pressure F in the direction of the vessel 5. In the mounted state, the surface temperature probe 1 is held on the vessel 5 using attachment means (not shown).

Since the differences between the two substantially planar contact surfaces 6 and 7 are comparatively small, a thin layer of the metal foam 4 suffices.

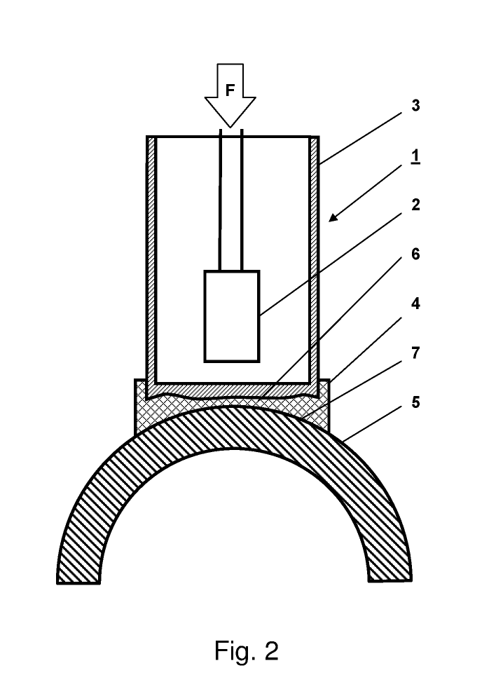

Using the same reference signs for the same means, FIG. 2 shows a surface temperature probe 1 which has a substantially planar first geometric contact surface 6. Said surface temperature probe 1 is mounted on the wall of a vessel 5, the second geometric contact surface 7 of which is curved.

In contrast to the embodiment in FIG. 1, in this case a substantially planar first contact surface 6 meets a curved second contact surface 7. The contact gap between the two contact surfaces 6 and 7 extends to the edges of the contact surfaces 6 and 7.

A metal foam 4 which fills the contact gap is inserted in said contact gap between the first geometric contact surface 6 of the surface temperature probe 1 and the second geometric contact surface 7 of the wall of the vessel 5. In addition, the surface temperature probe 1 is mounted on the vessel 5 by means of a contact pressure F in the direction of the vessel 5. In the mounted state, the surface temperature probe 1 is held on the vessel 5 using attachment means (not shown).

Since the differences between the two contact surfaces 6 and 7 increase towards the edges of the contact surfaces 6 and 7, a thicker metal foam 4 is used which is heated for mounting.

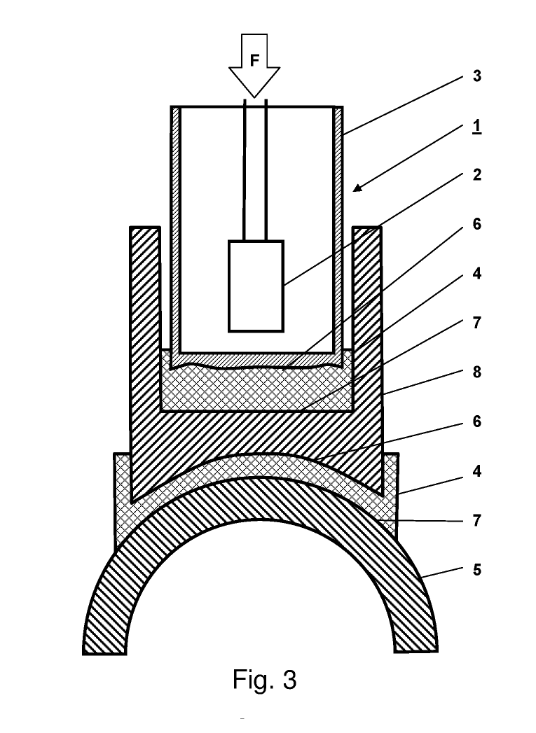

Using the same reference signs for the same means, FIG. 3 shows a surface temperature probe 1 comprising a substantially planar first geometric contact surface 6 which is equipped with an adapter 8 for application to a curved second geometric contact surface 7. In this case, the surface of the adapter 8 facing the surface temperature probe 1 forms the second geometric contact surface 7 which is substantially planar and corresponds to the first geometric contact surface 6 of the surface temperature probe 1. The curved surface facing the vessel 5 forms the first geometric contact surface 6 which corresponds to the second geometric contact surface 7 of the wall of the vessel 5.

The contours of the respective corresponding first and second contact surfaces 6 and 7 each differ from one another so as to form a contact gap. A metal foam 4 which fills the contact gap is inserted in these contact gaps between the respective corresponding first and second contact surfaces 6 and 7.

In addition, the surface temperature probe 1 is mounted on the vessel 5 by means of a contact pressure F in the direction of the vessel 5. The assembly process can comprise one step or two steps. In the one-step assembly process, the surface temperature probe 1 is brought into contact with the adapter 8, the adapter 8 is brought into contact with the vessel 5 and the entire assembly is pressed in one step. In the two-step assembly process, the surface temperature probe 1 is preferably brought into contact with the adapter 8 and pressed. The unit consisting of the surface temperature probe 1 and adapter 8 is then brought into contact with the vessel 5 and pressed. In the mounted state, the surface temperature probe 1 is held on the vessel 5 using attachment means (not shown).

The first geometric contact surface 6 of the surface temperature probe 1 and the second geometric contact surface 7 of the adapter 8 are substantially planar. Since the differences between the two substantially planar contact surfaces 6 and 7 are comparatively small, a thin layer of the metal foam 4 suffices.

The first geometric contact surface 6 of the adapter 8 and the second geometric contact surface 7 of the vessel 5 are substantially spherically equidistant.

Since the differences between said two contact surfaces 6 and 7 are comparatively small, a thin layer of the metal foam 4 also suffices here.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B, and C” should be interpreted as one or more of a group of elements consisting of A, B, and C, and should not be interpreted as requiring at least one of each of the listed elements A, B, and C, regardless of whether A, B, and C are related as categories or otherwise. Moreover, the recitation of “A, B, and/or C” or “at least one of A, B, or C” should be interpreted as including any singular entity from the listed elements, e.g., A, any subset from the listed elements, e.g., A and B, or the entire list of elements A, B, and C.

### LIST OF REFERENCE SIGNS

1 Surface temperature probe

2 Temperature sensor

3 Sensor housing

4 Metal foam

5 Vessel

6, 7 Contact surface

8 Adapter

F Contact pressure

1. A surface temperature probe, comprising:
a first geometric contact surface configured to determine a temperature in a vessel including a second geometric contact surface,
wherein the first geometric contact surface contacts the second geometric contact surface in a punctiform and/or linear manner,
wherein the first geometric contact surface is variably spaced apart from the second contact surface at least in part
wherein a metal foam is provided between the first geometric contact surface and the second geometric contact surface.

2. The probe of claim 1, wherein the first geometric contact surface contacts the second geometric contact surface in a punctiform manner.

3. The probe of claim 1, wherein the first geometric contact surface contacts the second geometric contact surface in a linear manner.

4. The probe of claim 1, wherein the first geometric contact surface contacts the second geometric contact surface in a punctiform and linear manner.

5. The probe of claim 1,wherein the metal foam comprises a metal having high heat conductivity.

6. The probe of claim 1,wherein the metal foam consists essentially of a metal having high heat conductivity.

7. The probe of claim 1,wherein the metal foam consists of a metal having high heat conductivity.

8. The probe of claim 1, wherein the metal foam comprises silver, copper, and/or aluminum.

9. The probe of claim 1, wherein the metal foam comprises a metal alloy.

10. The probe of claim 1, wherein the metal foam has a high porosity.

11. The probe of claim 1, wherein the metal foam has a metal foam pore volume of between 80 and 95 vol. %.

12. The probe of claim 1, wherein the metal foam has a pore size of <1 mm.

13. The probe of claim 1, wherein the metal foam has a thickness of from 1 to 4 mm.

14. The probe of claim 1, further comprising:
an irregularly folded metal foil, which has a metal foam structure, arranged between the first and second geometric contact surfaces.

15. The probe of claim 1, wherein the metal foam is preformed to rough dimensions of a contact gap between the first and second geometric contact surfaces.

16. The probe of claim 1, wherein the metal foam is filled at least in part with a soft material of high thermal conductivity.

17. The probe of claim 16, wherein the metal foam is filled with a heat-conducting paste.

18. The probe of claim 16, wherein the metal foam is filled with a metal having a low melting temperature.

19. The probe of claim 18, wherein the metal foam comprises tin and/or indium.

20. The probe of claim 16, wherein the metal foam has a pore size of <0.5 mm
